(19) United States
(12) Patent Application Publication
(10) Pub. No.: US 2015/0116366 A1
(43) Pub. Date: Apr. 30, 2015

(54) TABLET ORIENTATION

(71) Applicant: Société BIC, Clichy Cedex (FR)

(72) Inventors: Béatrice Daveney, La Gerenne Colombes (FR); Sylvain Giroudon, Montrouge (FR)

(21) Appl. No.: 14/390,864

(22) PCT Filed: Mar. 26, 2013
(86) PCT No.: PCT/FR2013/050640

§ 371 Date: Oct. 6, 2014

(30) Foreign Application Priority Data
Apr. 6, 2012 (FR) 12 53233

(51) Int. Cl. G09G 5/38; G06F 3/01

(52) U.S. Cl. CPC G09G 5/38; G06F 3/011; G09G 2340/0492; G09G 2354/00
USPC 345/659

(57) ABSTRACT

A system that includes a computer storing a list of users, and for each user a handedness parameter, a plurality of tablets, and a display circuit arranged to display a content on the screen of one of the tablets in a manner that is appropriate depending on whether the user is right- or left-handed. In addition, the invention also relates to a method performed by the system, to a computer program performing the above-mentioned method, and to a storage medium including such a computer program.

### CROSS REFERENCE TO RELATED APPLICATIONS

This application is a national stage application of International Application No. PCT/FR2013/050640, filed on Mar. 26, 2013, which claims the benefit of French Patent Application No. 1253233, filed on Apr. 6, 2012, the entire contents of both applications being incorporated herein by reference.

### BACKGROUND OF THE INVENTION

1. Field of the Invention

The embodiments of the present invention relate to the field of tablets, and in particular those used in the context of providing electronic assistance in teaching, in particular teaching young children (nursery school or primary school pupils).

2. Description of Related Art

Certain teaching techniques make use of tablets, which are very flat laptop computers with the majority of one of their two main faces being constituted by a screen. These tablets may be constituted in particular by conventional tablets designed for general purpose use (and not specifically for teaching young children). Such tablets may include one or more elements that are asymmetrical (relative to the screen), such as a webcam, a microphone, a loudspeaker, a trackball, a touch pad, a keyboard, one or more buttons, etc.

Such tablets may be touch tablets. They may then be used for writing directly on the screen, either with one or more fingers or else by means of a stylus, which may be preferable in the context of learning how to write since using a stylus is similar to using a pen (or more generally a “writing instrument”). Under such circumstances, a support for the stylus generally constitutes an element that is asymmetrical relative to the screen.

The existence of such asymmetrical elements is useful, but potentially awkward for young children if the tablet is wrongly oriented. Thus, if the stylus support is on the left of the screen and the pupil is right-handed, then the pupil runs the risk of needing to make an uncomfortable movement with the right hand in order to take hold of or put down the stylus (or of using the left hand which is clumsier than the right hand) and this may lead to the tablet being tipped over. Conversely, an asymmetrical element such as a microphone or a button may present sharp edges, protuberances, orifices, or slots that might catch (e.g. the sleeve of a garment, a bracelet, etc.), and for a right-handed pupil if it is situated on the right of the screen, such an element may increase the risk of catching, of discomfort, and of causing the tablet to be dropped. Other asymmetrical elements (e.g. a microphone or a webcam) are more likely to be obstructed by the right arm of a right-handed pupil if they are on the right of the screen, and this can impede or indeed prevent such elements being used to input information (e.g. audio and video recordings).

The orientation of the tablet can thus be non-optimum from an ergonomic point of view for use by a young child.

The embodiments of the present invention seek to improve the situation.

One aspect of the embodiments of the present invention provide an electronic system for providing assistance in teaching, the system comprising:
a computer storing a list of users, and for each user, a handedness parameter capable of taking two
values, one of which indicates that the user is right-handed and the other that the user is left-handed;
a plurality of tablets arranged to communicate with the computer, each tablet comprising a screen, a user identification circuit, and an asymmetrical element; and
a display circuit arranged to display a content on the screen of a tablet in a first orientation if the handedness parameter corresponding to the current user of the tablet, as determined by the user identification circuit of the tablet, has a first one of the two handedness parameter values, and in a second orientation if the parameter has the second of the two handedness parameter values.

This system is advantageous in that it provides for the tablet having a different orientation depending on whether the user is right- or left-handed, thereby making the tablet more ergonomic depending on the handedness of the user.

An aspect of the embodiments of the present invention provide a method of electronically providing assistance by means of a system comprising:
a computer storing a list of users, and for each user, a handedness parameter that can take two values, one of which indicates that the user is right-handed and the other that the user is left-handed;
a plurality of tablets arranged to communicate with the computer, each tablet comprising a screen, a user identification circuit, and an asymmetrical element; and
a display circuit arranged to display a content on the screen of one of the tablets; the method comprising:
a) identifying the user of a tablet with its identification circuit;
b) determining the handedness parameter associated with the identified user; and
c) selecting a first orientation for displaying the content by the display circuit if the handedness parameter corresponding to the identified user has a first of the two handedness parameter values, and a second orientation if the parameter takes the second of the two handedness values.

This method is advantageous in that it provides for the tablet having a different orientation depending on whether the user is right- or left-handed, thereby making the tablet more ergonomic depending on the handedness of the pupil.

An aspect of the embodiments of the present invention relate to a computer program having a series of instructions performing a method of the present invention when the instructions are executed by one or more processors.

Another aspect of the present invention provides a non-transitory computer readable storage medium including a computer program of the present invention.

These programs and storage media provide the advantages of the method together with increased flexibility compared with a purely hardware implementation of the present invention (in particular modifying or updating the system can be made easier).

Other aspects, objects, and advantages of the present invention appear in non-limiting manner on reading the following description of some of its embodiments.

The embodiments of the present invention can also be better understood with the help of drawings, in which:

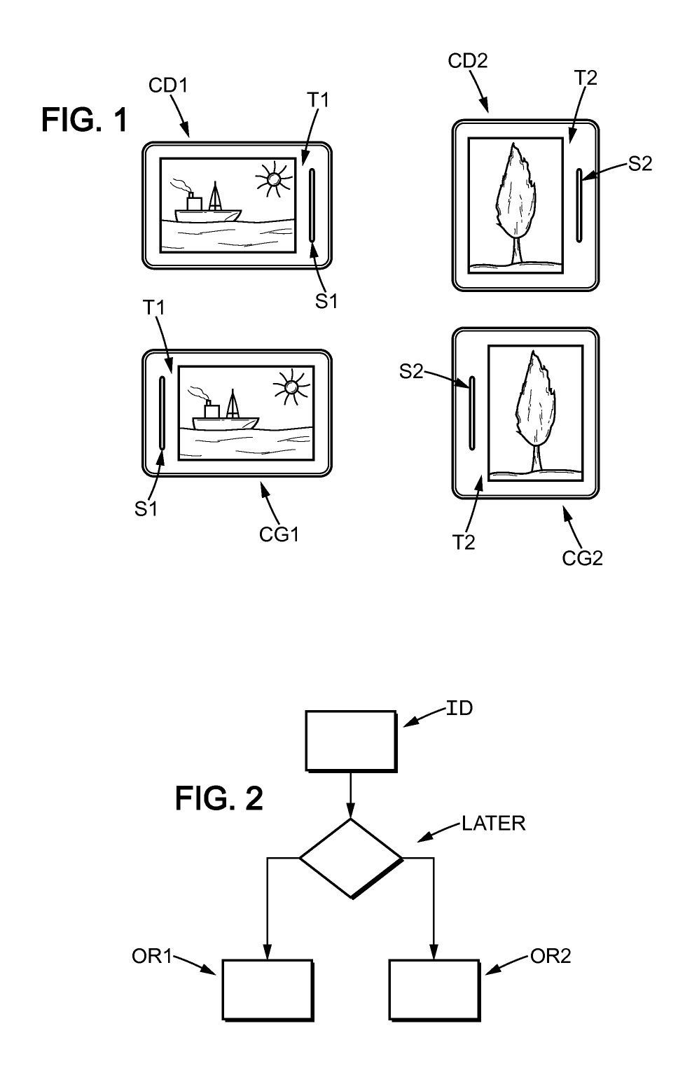

FIG. 1 shows various results obtained using a system in an embodiment; and

FIG. 2 shows various steps of a method in a possible implementation.

FIG. 1 shows two tablets T1, T2 of a system in an embodiment.

The first tablet T1 has a rectangular touch screen and a stylus support S1 adjacent to one of the short sides of the rectangle defining the screen.

The second tablet T2 has a rectangular touch screen and a stylus support S2 adjacent to one of the long sides of the rectangle defining the screen.

Each of the two tablets is configured to display either a view of the sea, a boat, and the sun, or a view of a tree. The pupil is supposed to look at the displayed view when it is the right-way-up (sky above the sea, or ground at the bottom).

The view of the boat for the first tablet T1 is in landscape mode, whereas the view of the tree for the second tablet T2 is in portrait mode.

The first tablet T1 is shown in a configuration CL1 for a left-hander and in a configuration CR1 for a right-hander, in a possible embodiment.

The second tablet T2 is shown in a configuration CL2 for a left-hander and in a configuration CR2 for a right-hander, in a possible embodiment.

The configuration is selected automatically by the system.

One possible embodiment of the present invention relates to an electronic system for providing assistance in teaching.

The system comprises a teaching computer storing a list of pupils, and for each pupil a handedness parameter that can take two values, one of which indicates that the pupil is right-handed and the other that the pupil is left-handed. In an embodiment, this handedness parameter is defined by a third party (e.g. by a teacher), i.e. by a person other than the pupil (since this operation might be too complex for the pupil).

The handedness parameter may have more than two values, for example it may have a particular value to indicate that a pupil is fully ambidextrous, or another particular value to indicate that the handedness of the pupil cannot be determined, or another value to indicate that this handedness is not known (whether or not it can be determined), with this value possibly being the value by default.

The teaching computer may be a conventional personal laptop computer having suitable software in an embodiment. Instead of a laptop computer, it could equally well be an office computer (having a tower, a separate screen, and a separate keyboard) together with suitable software, or any control console having suitable software.

The teaching computer may also be constituted by a plurality of elements. For example, the teaching computer may be a physical server (storing the list of pupils and the handedness parameters) associated with a laptop or office computer providing a teacher with a user interface (the server not necessarily having a screen or a keyboard). The physical server may be located in the classroom, e.g. in a docking station, and may communicate with the office or laptop computer (which may for example be found on the desk of the teacher in the classroom) via a wired connection (Ethernet, etc.) or via a wireless connection (e.g. WiFi).

The system comprises a plurality of tablets arranged to communicate with the teaching computer, each having a screen, a user identification circuit, and an asymmetrical element.

Given this asymmetrical element, the tablet is not necessarily equally ergonomic regardless of the orientation of the tablet relative to the user (and thus regardless of the position of the asymmetrical element), and the tablet might be more or less ergonomic depending on whether the user is right- or left-handed. In an embodiment, the asymmetrical element is a physical element of the tablet, thus constituting a characteristic that is intrinsic to the tablet (i.e. excluding an element displayed on the screen, where such an element depends on display instructions received by the tablet).

The asymmetrical element under consideration may be situated on a surface at the outer periphery of the screen (above, below, on the right, or on the left of the screen), and on the same face of the tablet as the screen. In an embodiment, the asymmetrical element is an element that is stationary relative to the tablet. An asymmetrical element is considered as being stationary if it is fastened to the tablet at a particular location and can be fastened to other locations of the tablet only by a person other than a young child (for example this may require the use of a screwdriver). In an embodiment, the asymmetrical element may be movable within fixed limits (e.g. a trackball or a switch), however it is still considered as being “stationary” in the meaning of the present invention if its potential movements remain confined to a narrow zone of the tablet (a zone having a dimension of the same order as the asymmetrical element). The asymmetrical element may be a webcam, a microphone, a loudspeaker (even though there may equally well be two loudspeakers possibly arranged symmetrically to each other relative to the screen, for producing stereophonic sound), a trackball, a touch pad, a keyboard, one or more buttons, etc. In an embodiment, the screen of the tablet is a touch screen. The asymmetrical element may be a stylus support (where the stylus is usable for inputting information to a touch screen of the tablet).

The tablet may have a plurality of asymmetrical elements (e.g. both a stylus support and a webcam). Under such circumstances, in an embodiment, the teaching computer may be configured to define a priority asymmetrical element (the element to which most account is to be given when defining the orientation of the tablet). Depending on the age of the pupils, or on the profile of the class (more or less unruly, etc.), or indeed on the preferences of the teacher, it can happen that a different asymmetrical element is selected as being more important than the others when selecting the orientation of the tablet (for example it may be that the webcam is not used with children under six years old, or simply that the teacher does not intend to use it, and therefore that obstructing the field of view of the webcam need not necessarily be troublesome for a given class). This selection may be made using a graphical interface. In an embodiment, selecting the asymmetrical element is replaced by selecting a preferred orientation for a given configuration (the orientation being implicitly due to the asymmetrical element that is stationary relative to the tablet, or to a plurality of asymmetrical elements, but without necessarily identifying the asymmetrical element(s)).

In particular, the tablets may be wireless touch tablets (e.g. having a WiFi wireless communications circuit) suitable for communicating with the teaching computer (e.g. the server of the teaching computer when the teaching computer includes such a server) by means of WiFi communication (or using any other suitable wireless protocol).

The system includes a display circuit arranged to display an educational content on the screen of one of the tablets in a first orientation if the value of the handedness parameter corresponding to the current user of the tablet, as determined by the user identification circuit of the tablet, is a first of the two values for the handedness parameter, and a second orientation if the parameter is the second of the two values for the handedness parameter.

The display of an educational content can thus be oriented differently depending on whether the pupil using the tablet on which the educational content is being displayed has been identified as being a right-handed pupil or a left-handed pupil.

The user identification circuit may be a processor (it may even be a processor that already exists in the tablet, such as a main processor), associated with a memory storing a program suitable for performing identification.

The identification circuit may be arranged to verify with the teaching computer that the identifier that has been input does indeed correspond to a pupil in the class. The identification circuit may also be a dedicated electronic circuit, such as an application-specific integrated circuit (ASIC) or a field-programmable gate array (FPGA), or indeed an electronic circuit made entirely to measure, or a dedicated microcontroller. It may also be a combination of a component of the tablet and a component of the teaching computer. The identification circuit may thus obtain a list of pupils stored in the teaching computer from a component of the teaching computer, may present this list on the screen of the touch tablet, and ask the user to click on the user's name. The circuit may also ask the users to write their names (by clicking on displayed letters or by using a keyboard). In one possible embodiment, the identification circuit does no more than display the information transmitted by the teaching computer (e.g. a list of pupils in the form of a transmitted JPEG-format image), leaving the teaching computer to select the user (an index in a list, or the coordinates of a point selected on the screen, etc.). The teaching computer then itself determines which pupil is concerned (and optionally transfers pupil identification to a component of the identification circuit situated in the tablet). The tablet can thus be interchangeable (and not tied to any particular pupil), and thus each time pupils take tablets for an exercise that needs a tablet, they may very well use different tablets.

The display circuit may be a processor (it may even be a processor that already exists in the tablet, such as its main processor), in association with a memory storing a program adapted to performing the method. It may also be a graphics processor, a dedicated electronic circuit such as an ASIC or an FPGA, or an electronic circuit made entirely to measure, or a dedicated microcontroller.

The first (as well as the second) orientation is defined by an arbitrary angle of rotation (lying in the range 0° to 359.9°) for rotating the educational content before displaying it on the screen.

These first and second orientations may thus each be represented by an angle in the range 0° to 359.9° (clearly it could be expressed in other units for measuring angle) between a reference vector of the tablet screen (which may be selected arbitrarily, once and forever, i.e. a vector that is fixed relative to the screen, which itself is generally fixed relative to the tablet, unless the screen is movable relative to the tablet) and a content reference vector (which may likewise be selected arbitrarily, once and forever, i.e. a vector that is fixed relative to the content). When the screen of the tablet is rectangular, its reference vector may be a vector connecting a corner of the rectangle defined by the screen to another corner on the same side of the rectangle. For each content, the reference value of the content may, for example, be a vector that is directed vertically from the bottom of the content towards the top of the content (clearly it is possible to decide once and forever that the vector should be a vector going horizontally from left to right, or in any direction at any angle defined arbitrarily, once and forever—but in the description below it is taken to be vertical, from bottom to top, by way of example). The content may be two-dimensional, and the bottom, the top, and the vertical of the content may be defined by the author of the content. The bottom, the top, and the vertical of the content may be determined by the format used for storing the data representing the content. For example, the content may be represented by an array of dots (e.g. in the form of a so-called “bitmap” image in the BMP format). In the BMP format, the pixels of the image are coded row by row starting from the bottom row of the image. The BMP format thus begins by specifying the bottom left dot of the image and then continues with the dot immediately adjacent on the right, and so on to the end of the bottom row. There follows the leftmost dot of the second row starting from the bottom, and so on to the rightmost dot of the row at the top of the image. The content may also be text having characters coded using an ASCII format beginning by the top left character, followed by the character immediately to its right and so on, new line characters serving to move on to the following line. The width of the ASCII text may then correspond to its longest line, and its height may correspond to the number of lines multiplied by the height of one line. Most content formats include an orientation that may be explicit or implicit. Starting from a single content format, it is then possible to define a vertical vector that is directed from the bottom towards the top of the content. For example, for a bitmap image of BMP type, the vector may be the vector connecting the bottom left dot to the top left dot of the same image. Likewise, for an ASCII text, the vector may be a vector perpendicular to the lines of text and directed from the bottom lines towards the top lines (or if there is only one line directed from the bottom of the characters towards the top of the characters).

In a possible variant, it is possible to correct a human error in the coding of the content. For example, a teacher may scan a photograph on paper while inadvertently placing the photograph upside-down in the scanner. On applying the digital image format produced by the scanner (e.g. a JPEG image), the image is displayed upside-down. It is possible to analyze the image with recognition software that is well known in the state of the art, and as a function of the result, to modify its orientation relative to the presumed orientation (derived solely from the format). Thus, face recognition software can recognize the orientation of a face and can automatically reorient the image so that the face is the right way up, and the same is true for landscapes, etc. It is possible to modify the files storing the digital image so that after modification the real orientation of the content is represented directly by its format. This is also possible for contents other than images (e.g. text, in particular rich text such as text in the rich text format (RTF) or HTML, etc.). In a variant, it is possible to rely on the intrinsic orientation of the storage format of the content even if analysis of the content reveals that it might not be the right way up (it might happen that the teacher has deliberately chosen to display an image upside-down). The teacher can thus activate or deactivate an option for automatically correcting the orientation of the content, e.g. with a button (or a check box, etc.) associated with suitable software.

The educational content is thus designed to be viewed with a preferred angle and a preferred direction (enabling the position of the body and in particular of the back and the neck to be optimized). For example, a landscape image is typically intended to be viewed with the sky at the top and the ground at the bottom. Likewise, a text is generally meant to be read from left to right, while the right way up (and not inclined at an angle or upside-down). This preferred angle and direction may be intrinsic to the data format used for representing the educational content, as mentioned above.

Thus, by drawing segments in the following order between the following points: pupil's left eye; pupil's right eye; right end of a horizontal line of text displayed on the screen of the tablet for which the pupil is the identified user; left end of the same horizontal line of text; and back to the pupil's left eye; a plane figure should be drawn, and more precisely a convex isosceles trapezoid, when the pupil is in a comfortable position (implying that the pupil's torso is in a symmetrical configuration and that the plane of symmetry of the torso coincides with the plane of symmetry of the skull).

Nevertheless, the first and second orientations relate to the position of the tablet, while the position of the pupil relative to the position of the tablet is unknown, a priori. If the tablet is not properly located relative to the pupil, then the figure formed as specified in the above paragraph (and when the educational content is text presented in the usual manner) is not a convex isosceles trapezoid, but may for example be a non-isosceles convex trapezoid (if the pupil is offset to the right or the left of the tablet), a crossed quadrilateral (if the tablet is upside-down relative to the pupil), a non-trapezoidal quadrilateral, or indeed a three-dimensional figure. The pupil will then doubtless spontaneously move and/or turn the tablet in order to see the educational content in the manner most comfortable for the pupil. The need to orient the tablet as a function of a displayed image can in itself constitute an orientation exercise that is of interest from an educational point of view (on the same lines as pupils identifying themselves by clicking on their own name before using the tablet constitutes a name-recognition exercise that is often of interest). The first image to be displayed may be an image required for pupil identification. This first image may be a list of names from which the pupil must recognize his or her own name (in order to be connected). Depending on the configuration of the tablet, the list may be duplicated (one the right-way up, another upside-down), so that the list is easily readable both by a right-hander and by a left-hander. Alternatively, the list of names may be displayed once only but with an orientation that is equally good for a right-hander and for a left-hander. For example, with a tablet in which the only asymmetrical element is the stylus support, an orientation in which the stylus support is at the top or the bottom of the screen is equally ergonomic for right-handers and left-handers. In an embodiment, a teacher may perform the initial operation of orienting the tablet for a pupil (if the pupil does not manage). The fact that the pupils might, where appropriate, need to reorient the tablet does not constitute a drawback compared with the prior art (independently of the fact that it might constitute a useful exercise, but one that is not necessarily wanted at this stage of a session). This same problem of tablet orientation arises independently of the present invention.

The pupil (or the teacher on behalf of the pupil) thus needs to select an orientation for the tablet relative to the pupil (which orientation is determined by the first or second orientation imposed on the educational content relative to the tablet) that is defined as being ergonomic for the pupil as a function of the pupil's handedness.

In an embodiment, the electronic system for providing assistance in teaching includes a display circuit arranged to select the first orientation so that the asymmetrical element is other than at the left of the screen when the tablet is oriented in this first orientation, and to select the second orientation so that the asymmetrical element is other than at the right of the screen when the tablet is oriented in the second orientation.

This is advantageous, in particular when the screen is not circularly symmetrical (when the screen is not a disk). Under such circumstances, depending on the format of the screen, and on the nature of the educational content to be displayed, it may not be possible to select the position of the asymmetrical element completely freely (i.e. there may exist only a limited number of possibilities), it then being possible merely to exclude the positions that are the most awkward.

For example, there exist only two possibilities for displaying an image of elliptical shape on a screen of elliptical shape and having the same dimensions. There exist only three possibilities for displaying an image contained in an equilateral triangle on a screen of shape corresponding to the same equilateral triangle, four possibilities with a square, two with a rectangle, etc.

With a screen of rectangular shape, and in a frame of reference having as axes one axis running along a small side of the rectangle surrounding the screen and another axis running along a long side of the rectangle surrounding the screen, an asymmetrical element may occupy specifically one of the following eight positions:

TR: above and to the right of the screen;

TL: above and to the left of the screen;

BR: below and to the right of the screen;

BL: below and to the left of the screen;

SB: below the screen and excluding the above-specified positions (“strictly” below);

ST: above the screen and excluding the above-specified positions (“strictly” above)

SL: to the left of the screen excluding the above-specified positions (“strictly” to the left); and

SR: to the right of the screen to the exclusion of the above-specified positions (“strictly” to the right).

The “right” position thus means: strictly to the right, above and to the right, or below and to the right.

The “left” position thus means: strictly to the left, above and to the left, or below and to the left.

The “above” position thus means: strictly above, above and to the left, or above and to the right.

The “below” position thus means: strictly below, below and to the left, or below and to the right.

In addition, for a rectangular screen, as mentioned there are only two possibilities for displaying a rectangular image having the same size as the screen.

Thus, there exist only two possible positions for the asymmetrical element that can be selected by changing orientation.

If it is the TR position, it may go to the BL position (and vice versa).

If it is in the TL position, it may go to the BR position (and vice versa).

If it is in the ST position, it may go to the SB position (and vice versa).

If it is in the SL position, it may go to the SR position (and vice versa).

For each possible position, it is appropriate to decide that is the least troublesome (or the most ergonomic).

In general, the positions to the right (be they TR, SR, or BR) or to the left (be they TL, SL, or BL) can turn out to be discriminatory, i.e. they can be troublesome for a pupil depending on whether the pupil is left- or right-handed, and it may be advantageous to avoid those positions.

In certain embodiments, only the positions SR and BR or SL and BL, as the case may be, are discriminatory (the top positions not being troublesome since they are typically not reached by the hand or the arm when the pupil places the dominant hand on the screen for writing).

In an embodiment, a right-handed pupil must not have an asymmetrical element on the right (where it might be troublesome), and likewise a left-handed pupil must not have an asymmetrical element on the left (where it might be troublesome). For example, a teacher may decide not to use a stylus in classes with pupils who are less than four years old (since they are not sufficiently skillful with a stylus for a given type of exercise), and have them write directly with their fingers. Under such circumstances, the stylus carrier may be troublesome (even if the stylus has been removed) if it is on the same side as the pupil's dominant hand.

Conversely, when the teacher has the pupils write with a stylus (e.g. because they are at least four years old, or if the teacher is making children aged less than four years perform exercises that are easy with a stylus in order to familiarize them with this tool), it is on the contrary the fact that the pupil needs to look for the stylus on the left if the pupil is right-handed (and vice versa for the left-handed) that can be found to be troublesome. Thus, in an embodiment, the system prefers a display in which the asymmetrical element is on the right for a right-handed pupil and on the left for a left-handed pupil.

In other embodiments, it may be that the positions SB or ST are discriminatory (but often for reasons that are independent of whether the pupil is right- or left-handed). For example, it may be troublesome for the pupil to catch on a large asymmetrical element in the SB position while writing on the screen, or on the contrary for the pupil to be obliged to stretch to the top of the screen in order to actuate an asymmetrical element in the ST position.

In certain configurations, both possible orientations (e.g. SB and ST) may be equally ergonomic (in which case they are not discriminatory). Under such circumstances, it is possible to select one of the two positions arbitrarily (or as described in detail below) to select one of the positions by involving additional parameters that are specific to the tablet).

In an embodiment, the system has a configuration module (which may be integrated in the teaching computer, or if the teaching computer is associated with a server, in the server). Where appropriate, the configuration module contains a set of default configurations (preferring one orientation over another depending on the age of the pupils, on the type of the exercise, on a priority list among various different asymmetrical elements, etc.). The configuration module also enables teachers to define their own profiles (preferring, in a manner similar to the configuration by default, one orientation over another depending on the age of the pupils, on the type of the exercise, on a priority list from among various different asymmetrical elements, etc.). Personalized profiles may involve personalized types of exercise, or may make selections that are opposite to the selection by default under circumstances that are identical.

Thus, once a profile has been selected, the orientation of the tablets of the pupils is determined by the profile (depending on whether the pupils are right- or left-handed).

The left and the right of the screen may be defined as a function of the displayed content (meaning that there is a particular orientation of the tablet that enables the content to be seen correctly) for screens other than rectangular screens. These definitions can be understood intuitively, but it is also possible to define them mathematically.

For example, for a tablet having a surface that is plane with a plane screen of arbitrary shape, the left portion of the screen may be defined as follows. Initially, a left vector (L_V) is defined as being the vector that results from applying a vector rotation to the reference vector of the screen through an angle equal to the selected orientation (first or second orientation) plus 90°. Thereafter, the left periphery of the screen is defined as being a set of points L_PER_PT of the screen such that for any strictly positive scalar k, L_PER_PT+k*L_V is not a point of the screen. Finally, the left of the screen is defined as being the zone of the tablet defined by the set of points L_ZONE_PT of the tablet such that there exists a strictly positive scalar k such that L_ZONE_PT=L_PER_PT+k*L_V. The zone other than to the left of the screen then designates the zone other than the screen and other than to the left of the screen.

Likewise, the right portion of the screen may be defined as follows. Initially, a right vector (R_V) is defined as being the vector that results from applying a vector rotation to the reference vector of the screen through an angle equal to the selected orientation (first or second orientation) minus 90°. Thereafter, the right periphery of the screen is defined as being a set of points R_PER_PT of the screen such that for any strictly positive scalar k, R_PER_PT+k*R_V is not a point of the screen. Finally, the right of the screen is defined as being the zone of the tablet defined by the set of points R_ZONE_PT of the tablet such that there exists a strictly positive scalar k such that R_ZONE_PT=R_PER_PT+k*R_V. The zone other than to the right of the screen then designates the zone other than the screen and other than to the right of the screen.

The above definitions of left and right are definitions for strictly left and strictly right in the meaning of the examples given above for rectangular screens (SR and SL). In an embodiment, the electronic system for providing assistance in teaching includes a tablet having a screen that is substantially rectangular and in which the asymmetrical element lies in a half-plane defined by an axis passing through one of the short sides of the rectangle corresponding to the screen and not including the rectangle.

When the display is configured in landscape mode, and if the value of the handedness parameter of the current user of the tablet as determined by the user identification circuit of the tablet is a first one of two handedness parameter values, the display circuit is arranged to select as its first orientation an orientation such that the asymmetrical element lies on the right of the screen (for a pupil located in front of the screen so as to view the educational content in appropriately oriented manner). That the manner in which the educational content is oriented is appropriate may be assessed in particular on the basis of educational content consisting of text, with the above-described convex isosceles trapezoid test. The first orientation may correspond to no rotation of the educational content if the asymmetrical element is already on the right of the screen for a conventional display (e.g. a first orientation not modifying the display by default), and to rotating the educational content through 180° if the asymmetrical element is on the left of the screen.

In contrast, if the handedness parameter takes the second of the two values for the handedness parameter, the display circuit is arranged to select as its second orientation an orientation such that the asymmetrical element is on the left of the screen (for a pupil placed in front of the screen so as to view the educational content in appropriately oriented manner). This second orientation may correspond to no rotation of the educational content if the asymmetrical element is already on the left of the screen for a conventional display (i.e. a second orientation that does not modify the display by default), and to a rotation of the educational content through 180° if the asymmetrical element is on the right of the screen.

In an embodiment, the display circuit is itself arranged to configure the screen in landscape mode (i.e. so that the width of the display area is greater than its height), either on command (e.g. by a teacher), or as a function of the transmitted educational content. In an embodiment, the system identifies the educational content as landscape mode content by using the data format used for representing the content. This format can thus indicate that the content is wider than it is high (e.g. a bitmap image having more pixels per row than it has rows). In an embodiment, the educational content is defined as being landscape mode content by analyzing the type of content or what the content represents. For example, an ASCII text may have only one line (possibly a very long line) per paragraph (using new line signs only to go from one paragraph to the next) and the display circuit may match the text to the dimensions of the screen by automatically adding new line signs each time the end of a screen line is reached (which amounts to redimensioning the text). An ASCII text can then be arranged to be displayed in a mode by default (e.g. in landscape mode). Alternatively, the system may take account of the number of words in the ASCII text in order to select a display in landscape mode. Thus, an ASCII text which is very short (e.g. a sentence of fewer than ten words, may be displayed by default in landscape mode using large characters.

In an embodiment, the educational content is defined as landscape mode content with a parameter that is integrated in (or associated with) the educational content and that specifies that landscape mode is required, or at least is more appropriate. The parameter may constitute one or more items of metadata associated with the content and specifying the desired display mode (e.g. landscape mode). The system is then arranged to configure the display automatically in landscape mode.

Naturally, when the dimensions of the content do not correspond exactly to the dimensions of the screen, it is possible in conventional manner to proceed either with scaling the content (zooming out or zooming in until the content is displayed in full and occupies a maximum area of the screen), or else the content may be truncated (excluding non-essential portions that lie beyond the screen, as is done for example when truncating cinema films in 16/9 format).

In contrast, in the event that the system is configured in portrait mode, there is no guarantee that it is possible to select a left or a right position for the asymmetrical element. When it is not possible for the element to be placed on the right or on the left (i.e. when the asymmetrical element is in the ST or SB positions), one needs to select between the ST position and the SB position. When the applicable personalized profile (or default configuration) of the configuration module (or any other technique used for setting the rules that are to be applied when selecting orientation) specifies that one of the SB or ST positions is preferable in the context under consideration, the system may be arranged to select that position (where appropriate by applying a rotation through 180°).

Otherwise, one of the two positions may be selected by default (e.g. the ST position).

It is also possible to provide the following provisions for selecting between SB and ST. The tablets may be fitted with gyros (such as gyros of microelectromechanical system (MEMS) type). The gyro can measure the yaw angle (rotation about a vertical axis of the class). In an embodiment, the tablets are all stored with the same attitude in a stationary docking station (that also serves to recharge their batteries) while they are not in use. The term “attitude” specifies, in three dimensions, the directions of the three reference axes of an article relative to a reference frame. Each time a tablet is stored in the docking station, its gyro is reset to zero (to correct for drift of the gyro over time). The tablet is generally stored in this manner at least once every day since it is difficult to imagine the tablet being kept in disorganized manner for longer than a day. The tablets are put away, if only to enable them to be recharged by the station. Conventional classroom plans often have rows of pupils all facing towards the teacher. All of the pupils' tables are then parallel, and the pupils are all oriented in the same manner. The configuration module may be arranged to enable this orientation to be stored. By way of example, the teacher may identify his- or herself with a tablet using a configuration identifier (instead of a pupil identifier), and the gyro of the tablet should preferably just have been reinitialized in the docking station. The teacher can then place this tablet on a pupil's table with the tablet oriented in the pupils to teacher direction. The tablet may display a large arrow on the screen pointing to a symbolic representation of the teacher and with a symbolic representation of the pupils at its base in order to make the manipulation more intuitive. The teacher can then click on a link to transmit information from the reference gyro to the teaching computer. The gyro of a tablet can thus identify the yaw angle corresponding to a blackboard orientation (from the pupils to the teacher). Given the current orientation of the tablet, it is then possible to determine whether it is possible to minimize the rotation of the tablet by a pupil by selecting from among the two positions SB and ST that one which gives rise to the least rotation of the tablet.

In particular, if one of the positions SB and ST makes it possible to avoid any rotation, that position is selected. This situation is quite probable with a screen that is rectangular and that has only four potentially correct orientations for conventional applications (two in portrait mode and two in landscape mode). It is probable that a pupil will not orient a tablet at an angle other than 0°, 90°, 180°, or 270°, since those are the orientations that are the most natural. The use of the gyro thus makes it possible under certain circumstances to select the proper orientation without any need for the pupil to turn the tablet (by selecting between no rotation and rotation through 180°). Rotation through 90° may be necessary if the tablet is put in portrait orientation when it is to display landscape mode content, or vice versa.

In an embodiment, the tablets include not only a gyro but also accelerometers for measuring position in at least one horizontal plane of the classroom (by double integration). In this embodiment, the teaching computer is (or includes) a laptop computer used by the teacher (or the teacher may use a tablet of the same type as those used by the pupils). The teacher's computer also has accelerometers for measuring position at least in a horizontal plane of the classroom, and these accelerometers (like those of the tablets) are regularly reinitialized in the stationary docking station. The configuration module may be arranged to operate in the context of a non-conventional classroom layout (with an arbitrary distribution of tables, it being possible for some tables to surround the teacher, for example, or for tables to be arranged in groups that might possibly be of different sizes). Knowing its position, each tablet can determine the theoretical orientation of the pupil (vector going from the position of the tablet towards the theoretical position of the teacher, corresponding to the position of the laptop computer) and can thus select between the positions SB and ST, that one which requires least rotation (or as mentioned above that one which sometimes requires no rotation of the tablet as opposed to that one which requires rotation through 180°).

Furthermore, by having gyros and accelerometers integrated in the tablets it is possible to obtain other functions, in particular creating a plan of the classroom facilitating supervision of the class (e.g. a class supervision circuit, instead of displaying a list of pupils sorted alphabetically, may alternatively display a plan of the classroom corresponding to the real positions of the pupils in the classroom).

Instead of using gyros and/or accelerometers, or in addition to using them, the control module may include an interface enabling the orientation of a tablet to be forced from the teaching computer when a plurality of orientations are possible (SB and ST).

The teacher can thus see how the tablet(s) of one or more pupils is/are oriented, and instead of going up to the pupil's table, the teacher can change the orientation of the display merely by means of a click if the display was SB instead of ST (or vice versa) when both of those positions are possible.

In an embodiment, an electronic system for providing assistance in teaching includes a tablet with a screen that is substantially rectangular and the asymmetrical element lies in a half-plane defined by an axis running along one of the long sides of the rectangle corresponding to the screen and not including the rectangle.

When the display is configured in portrait mode, and if the handedness parameter of the current user of the tablet as determined by the user identification circuit of the tablet takes a first one of two handedness parameters, the display circuit is arranged to select as its first orientation an orientation such that the asymmetrical element lies on the right of the screen (for a pupil located in front of the screen so as to view the educational content in appropriately oriented manner).

The first orientation may correspond to no rotation of the educational content if the asymmetrical element is already on the right of the screen for a conventional display (e.g. a first orientation not modifying the display by default), and to rotating the educational content through 180° if the asymmetrical element is on the left of the screen.

In contrast, if the handedness parameter takes the second of the two values for the handedness parameter, the display circuit is arranged to select as its second orientation an orientation such that the asymmetrical element is on the left of the screen (for a pupil placed in front of the screen so as to view the educational content in appropriately oriented manner). This second orientation may correspond to no rotation of the educational content if the asymmetrical element is already on the left of the screen for a conventional display (i.e. a second orientation that does not modify the display by default), and to a rotation of the educational content through 180° if the asymmetrical element is on the right of the screen.

In an embodiment, the display circuit is itself arranged to configure the screen in portrait mode (i.e. so that the height of the display area is greater than its width), either on command (e.g. by a teacher), or as a function of the transmitted educational content. In an embodiment, the system identifies the educational content as portrait mode content by using the data format used for representing the content. This format can thus indicate that the content is taller than it is wide (e.g. a bitmap image having more rows than pixels per row). In an embodiment, the educational content is defined as being portrait mode content by analyzing the type of content or what the content represents. For example, an ASCII text may have only one line (possibly a very long line) per paragraph (using new line signs only to go from one paragraph to the next) and the display circuit may match the text to the dimensions of the screen by automatically adding new line signs each time the end of a screen line is reached (which amounts to redimensioning the text). An ASCII text can then be arranged to be displayed in a mode by default (e.g. in portrait mode). Alternatively, the system may take account of the number of words in the ASCII text in order to select a display in portrait mode. Thus, an ASCII text which is very long (e.g. having more than one thousand characters) may be displayed by default in portrait mode. In an embodiment, the educational content is defined as portrait mode content with a parameter that specifies that portrait mode is required, or at least is more appropriate. The parameter may constitute one or more items of metadata associated with the content and specifying the desired display mode (e.g. portrait mode). The system is then arranged to configure the display in portrait mode.

In contrast, in the event that the system is configured in landscape mode, there is no guarantee that it is possible to select a left or a right position for the asymmetrical element. When it is not possible for the element to be placed on the right or on the left (i.e. when the asymmetrical element is in the ST or SB positions), one needs to select between the ST position and the SB position. When the applicable personalized profile (or default configuration) of the configuration module (or any other technique used for setting the rules that are to be applied when selecting orientation) specifies that one of the SB or ST positions is preferable in the context under consideration, the system may be arranged to select that position (where appropriate by applying a rotation through 180°).

Otherwise, one of the two positions may be selected by default (e.g. the ST position).

It is also possible to provide the provisions set out in the previously-described implementation, and make use of a gyro and/or accelerometers. Between the positions SB and ST, the system may thus select that one which requires the least rotation (or as mentioned above that one which, sometimes, requires no rotation as opposed to that one which requires rotation through 180°).

When the two rotations for reaching SB or for reaching ST are equivalent (i.e. if the tablet is in landscape mode and it is portrait mode that is requested), it is possible to select one or the other randomly and then if the pupil turns in the wrong direction, to correct automatically by selecting the other position. This is naturally also possible with a tablet that is oriented in portrait mode when it should have been oriented in landscape mode.

In an embodiment, the display circuit is arranged to display educational content having various different elements. The system has a graphical interface circuit arranged to arrange the various elements of the educational content on the screen of one of the tablets in a manner that varies depending on whether the handedness parameter of the current user of the tablet, as determined by the user identification circuit of the tablet, takes the first or the second of the two values of the handedness parameter. For example, the tablet may display a virtual keyboard on the screen so that the pupil can click on the displayed letters in order to write them. The keyboard may be placed either on one side of the screen or on the other depending on whether the pupil is left- or right-handed. Thus, not only are the tablets of a right-hander and of a left-hander not necessarily oriented in the same manner, but the content displayed thereon may also be different. It is possible to organize a hierarchy of the various elements of the content to be displayed. Those which are the most important (e.g. instructions for an exercise) may be displayed in a zone of the screen that is the least likely to be hidden by the pupil's hand (given the pupil's handedness), whereas elements that are less important may be placed in zones that are more likely to be seen less well by the pupil (e.g. bottom right of the screen for a right-handed pupil).

The graphical interface circuit may be a processor (it may even be an already existing processor of a tablet or of the teaching computer, such as its main processor), associated with a memory storing a program adapted to performing the educational content display procedure. The circuit may also be a dedicated electronic circuit such as an ASIC or an FPGA, or an electronic circuit made entirely to measure, or a dedicated microcontroller. It may also be a combination of a component of the tablet and a component of the teaching computer.

FIG. 2 shows a method according to an embodiment.

In a step ID, a user identification circuit of a tablet identifies the user of a tablet (from a list of pupils in a class).

In a step R_L, the method determines whether the user is right- or left-handed.

In a step OR1, if the user is right-handed, a first orientation is selected for displaying educational content.

In a step OR2, if the user is left-handed, a second orientation is selected for displaying the same educational content.

According to a possible embodiment, a method of electronically providing assistance in teaching makes use of a system comprising:
a teaching computer storing a list of pupils, and for each pupil a handedness parameter that can take two values, one indicating that the pupil is right-handed and the other that the pupil is left-handed;
a plurality of tablets arranged to communicate with the teaching computer, each comprising a screen and a user identification circuit; and
a display circuit arranged to display educational content on the screen of one of the tablets.

The method comprises identifying the user of a tablet with its identification circuit.

The method comprises determining the handedness parameter that is associated with the identified user.

The method comprises selecting a first orientation for displaying educational content by the display circuit if the handedness parameter corresponding to the identified user has a first one of the two handedness parameter values, and a second orientation if the parameter has the second one of the two handedness parameter values.

According to a possible embodiment, the method comprises selecting the first orientation so that the asymmetrical element is not on the left of the screen when the tablet is oriented in the first orientation, and selecting the orientation in such a manner that the asymmetrical element is not on the right of the screen when the tablet is oriented in the second orientation.

According to a possible embodiment, the screen of the tablet is substantially rectangular and the asymmetrical element is located in a half-plane defined by an axis passing along one of the short sides of the rectangle corresponding to the screen and not including the rectangle. When the display is configured in landscape mode, and if the value of the handedness parameter of the current user of the tablet as determined by the user identification circuit of the tablet is a first one of the two handedness parameter values, the method comprises the display circuit selecting as the first orientation an orientation such that the asymmetrical element is on the right of the screen. If the value of the handedness parameter is the second of the two handedness parameter values, then the display circuit selects as the second orientation an orientation such that the asymmetrical element is on the left of the screen.

According to a possible embodiment, the screen of the tablet is substantially rectangular and the asymmetrical element is located in a half-plane defined by an axis passing along one of the long sides of the rectangle corresponding to the screen and not including the rectangle. When the display is configured in portrait mode, and if the value of the handedness parameter of the current user of the tablet as determined by the user identification circuit of the tablet is a first one of the two handedness parameter values, the method comprises the display circuit selecting as the first orientation an orientation such that the asymmetrical element is on the right of the screen. If the value of the handedness parameter is the second of the two handedness parameter values, then the display circuit selects as the second orientation an orientation such that the asymmetrical element is on the left of the screen.

According to a possible embodiment, the display circuit is arranged to display an educational content having a plurality of elements. The method comprises distributing the various elements of the educational content on the screen of one of the tablets by means of a graphical interface circuit in a manner that differs depending on whether the handedness parameter of the current user of the tablet, as determined by the user identification circuit of the tablet, takes a first or the second of the two handedness parameter values.

According to a possible embodiment, a computer program comprises a series of instructions performing the method according to any of the implementations when the instructions are executed by one or more processors. The program may be written in particular in assembly language, in C, in Java, in C#, or in any other appropriate language. The language may be different for a program portion situated in a tablet and for a program portion situated in the teaching computer or in the various circuits depending on the embodiments of the present invention.

According to a possible embodiment, a non-transitory computer-readable storage medium stores a program as set out in the paragraph above. The storage medium may be a rewritable memory (e.g. of the electrically erasable programmable read-only memory (EEPROM) or flash memory type or of the battery-backed-up random access memory (RAM) type) or it may be non-rewritable memory (e.g. memory of the read-only memory (ROM) type). The memory may be integrated in a tablet, either directly on its motherboard, or in the form of a memory card (such as a micro-SD or other card). The storage medium may also be a magnetic medium of the hard disk type (possibly incorporated within a teaching computer).

The embodiments of the present invention is not limited to the embodiments described above by way of example; it extends to other variants.

The description above thus relates to methods and systems concerning tablets having screens of certain shapes (in particular of rectangular shape), but it is nevertheless possible to envisage using screens of other shapes, including shapes that are not perfectly plane (e.g. a screen that is concave or convex). Furthermore, reference has been made to displaying educational content in only two dimensions, however it is also possible to orient tablets that are provided with facilities for providing a three-dimensional display. Although providing assistance in teaching is an application that is particularly advantageous, numerous other applications are possible. The embodiments of the present invention is not limited to educational content, and in the examples given, any type of content could take the place of the educational content, and the users could be other than teachers and pupils. For example, an on-line game user might have a profile with a game server, which profile specifies whether the user is left- or right-handed. The game console of the player (a kind of tablet) can then display the game with an optimum orientation serving to improve the player's effectiveness (with speed and skill as improved in this way contributing to the player's performance). Furthermore, certain improvements are independent of one another, for example the docking station with the means for synchronizing accelerometers (and gyros if any) of the tablets may be implemented independently of other aspects of the present invention.

Implementations relating to the methods may be transposed to the systems, and vice versa.

1-12. (canceled)

13. An electronic system for providing assistance comprising:
a computer storing a list of users, and for each user, a handedness parameter capable of taking at least two values, one of which indicates that the user is right-handed and the other that the user is left-handed;
a plurality of tablets arranged to communicate with the computer, each tablet comprising a screen, a user identification circuit, and an asymmetrical element; and
a display circuit arranged to display a content on the screen of a tablet in a first orientation if the handedness parameter corresponding to the current user of the tablet, as determined by the user identification circuit of the tablet, has a first one of the two handedness parameter values, and in a second orientation if the parameter has the second of the two handedness parameter values.

14. The system according to claim 13, the display circuit being arranged to select the first orientation so that the asymmetrical element is not on the left of the screen when the tablet is oriented in the first orientation and to select the second orientation so that the asymmetrical element is not on the right of the screen when the tablet is oriented in the second orientation.

15. The system according to claim 13, wherein the screen of the tablet is substantially rectangular and the asymmetrical element is in a half-plane defined by an axis passing along one of the short sides of the rectangle corresponding to the screen and not including the rectangle, the display circuit being arranged, when the display is configured in landscape mode, and if the value of the handedness parameter of the current user of the tablet as determined by the user identification circuit of the tablet is a first of the two handedness parameter values, to select as the first orientation an orientation such that the asymmetrical element is on the right of the screen, and if the value of the handedness parameter is the second of the two handedness parameter values, to select as the second orientation an orientation such that the asymmetrical element is on the left of the screen.

16. The system according to claim 14, wherein the screen of the tablet is substantially rectangular and the asymmetrical element is in a half-plane defined by an axis passing along one of the short sides of the rectangle corresponding to the screen and not including the rectangle, the display circuit being arranged, when the display is configured in landscape mode, and if the value of the handedness parameter of the current user of the tablet as determined by the user identification circuit of the tablet is a first of the two handedness parameter values, to select as the first orientation an orientation such that the asymmetrical element is on the right of the screen, and if the value of the handedness parameter is the second of the two handedness parameter values, to select as the second orientation an orientation such that the asymmetrical element is on the left of the screen.

17. The system according to claim 13, wherein the screen of the tablet is substantially rectangular and the asymmetrical element is in a half-plane defined by an axis passing along one of the long sides of the rectangle corresponding to the screen and not including the rectangle, the display circuit being arranged, when the display is configured in portrait mode, and if the value of the handedness parameter of the current user of the tablet as determined by the user identification circuit of the tablet is a first of the two handedness parameter values, to select as the first orientation an orientation such that the asymmetrical element is on the right of the screen, and if the value of the handedness parameter is the second of the two handedness parameter values, to select as the second orientation an orientation such that the asymmetrical element is on the left of the screen.

18. The system according to claim 14, wherein the screen of the tablet is substantially rectangular and the asymmetrical element is in a half-plane defined by an axis passing along one of the long sides of the rectangle corresponding to the screen and not including the rectangle, the display circuit being arranged, when the display is configured in portrait mode, and if the value of the handedness parameter of the current user of the tablet as determined by the user identification circuit of the tablet is a first of the two handedness parameter values, to select as the first orientation an orientation such that the asymmetrical element is on the right of the screen, and if the value of the handedness parameter is the second of the two handedness parameter values, to select as the second orientation an orientation such that the asymmetrical element is on the left of the screen.

19. The system according to claim 15, wherein the screen of the tablet is substantially rectangular and the asymmetrical element is in a half-plane defined by an axis passing along one of the long sides of the rectangle corresponding to the screen and not including the rectangle, the display circuit being arranged, when the display is configured in portrait mode, and if the value of the handedness parameter of the current user of the tablet as determined by the user identification circuit of the tablet is a first of the two handedness parameter values, to select as the first orientation an orientation such that the asymmetrical element is on the right of the screen, and if the value of the handedness parameter is the second of the two handedness parameter values, to select as the second orientation an orientation such that the asymmetrical element is on the left of the screen.

20. The system according to claim 16, wherein the screen of the tablet is substantially rectangular and the asymmetrical element is in a half-plane defined by an axis passing along one of the long sides of the rectangle corresponding to the screen and not including the rectangle, the display circuit being arranged, when the display is configured in portrait mode, and if the value of the handedness parameter of the current user of the tablet as determined by the user identification circuit of the tablet is a first of the two handedness parameter values, to select as the first orientation an orientation such that the asymmetrical element is on the right of the screen, and if the value of the handedness parameter is the second of the two handedness parameter values, to select as the second orientation an orientation such that the asymmetrical element is on the left of the screen.

21. The system according to claim 13, the display circuit being arranged to display a content having a plurality of elements, the system including a graphical interface circuit arranged to distribute the various elements of the content on the screen of one of the tablets in different manner depending on whether the handedness parameter of the current user of the tablet as determined by the user identification circuit of the tablet takes a first or the second of the two handedness parameter values.

22. The system according to claim 14, the display circuit being arranged to display a content having a plurality of elements, the system including a graphical interface circuit arranged to distribute the various elements of the content on the screen of one of the tablets in different manner depending on whether the handedness parameter of the current user of the tablet as determined by the user identification circuit of the tablet takes a first or the second of the two handedness parameter values.

23. The system according to claim 15, the display circuit being arranged to display a content having a plurality of elements, the system including a graphical interface circuit arranged to distribute the various elements of the content on the screen of one of the tablets in different manner depending on whether the handedness parameter of the current user of the tablet as determined by the user identification circuit of the tablet takes a first or the second of the two handedness parameter values.

24. The system according to claim 16, the display circuit being arranged to display a content having a plurality of elements, the system including a graphical interface circuit arranged to distribute the various elements of the content on the screen of one of the tablets in different manner depending on whether the handedness parameter of the current user of the tablet as determined by the user identification circuit of the tablet takes a first or the second of the two handedness parameter values.

25. The system according to claim 17, the display circuit being arranged to display a content having a plurality of elements, the system including a graphical interface circuit arranged to distribute the various elements of the content on the screen of one of the tablets in different manner depending on whether the handedness parameter of the current user of the tablet as determined by the user identification circuit of the tablet takes a first or the second of the two handedness parameter values.

26. A method of electronically providing assistance with a system comprising:
a computer storing a list of users, and for each user, a handedness parameter that can take two values, one of which indicates that the user is right-handed and the other that the user is left-handed;
a plurality of tablets arranged to communicate with the computer, each tablet comprising a screen, a user identification circuit, and an asymmetrical element; and
a display circuit arranged to display a content on the screen of one of the tablets;
the method comprising:
a) identifying the user of a tablet with its identification circuit;
b) determining the handedness parameter associated with the identified user; and
c) selecting a first orientation for displaying the content by the display circuit if the handedness parameter corresponding to the identified user has a first of the two handedness parameter values, and a second orientation if the parameter has the second of the two handedness values.

27. The method according to claim 26, including, in step c), selecting the first orientation so that the asymmetrical element does not lie on the left of the screen when the tablet is oriented in the first orientation, and selecting the second orientation so that the asymmetrical element does not lie on the right of the screen when the tablet is oriented in the second orientation.

28. The method according to claim 26, wherein the tablet screen is substantially rectangular and the asymmetrical element lies in a half-plane defined by an axis passing via one of the short sides of the rectangle corresponding to the screen and not including the rectangle, and wherein, when the display is configured in landscape mode, and if the value of the handedness parameter of the current user of the tablet as determined by the user identification circuit of the tablet is a first one of the two handedness parameter values, the method comprises, in step c) selecting as the first orientation an orientation such that the asymmetrical element is on the right of the screen, and if the value of the handedness parameter is the second of the two handedness parameter values, selecting as the second orientation an orientation such that the asymmetrical element is on the left of the screen.

29. The method according to claim 26, wherein the tablet screen is substantially rectangular and the asymmetrical element lies in a half-plane defined by an axis passing via one of the long sides of the rectangle corresponding to the screen and not including the rectangle, and wherein, when the display is configured in portrait mode, and if the value of the handedness parameter of the current user of the tablet as determined by the user identification circuit of the tablet is a first one of the two handedness parameter values, the method comprises, in step c) selecting as the first orientation an orientation such that the asymmetrical element is on the right of the screen, and if the value of the handedness parameter is the second of the two handedness parameter values, selecting as the second orientation an orientation such that the asymmetrical element is on the left of the screen.

30. The method according to claim 26, wherein the display circuit is arranged to display a content comprising a plurality of elements, the method comprising:
distributing different elements of the content on the screen of one of the tablets by means of a graphical interface circuit in a manner that differs depending on whether the handedness parameter of the current user of the tablet as determined by the user identification circuit of the tablet has a first or the second one of the two handedness parameter values.

31. A computer program including a series of instructions performing the method according to claim 26, when the instructions are executed by one or more processors.

32. A non-transitory computer-readable storage medium including a computer program according to claim 31.
